(19) United States
(12) Patent Application Publication
(10) Pub. No.: US 2008/0284343 A1
(43) Pub. Date: Nov. 20, 2008

(54) LIGHT EMITTING DIODE LAMP, LIGHT EMITTING DIODE ASSEMBLY, AND LIGHT EMITTING DIODE STRING

(75) Inventors: KUN-SHENG KUO, Chu-Nan (TW); YUAN-FA CHU, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/870,109

(22) Filed: Oct. 10, 2007

(30) Foreign Application Priority Data
May 18, 2007 (CN) 200710074373.3

(51) Int. Cl. H05B 41/14

(52) U.S. Cl. 315/185 R; 315/312

(57) ABSTRACT

An exemplary light emitting diode (LED) lamp is provided. The LED lamp includes a base, an encapsulation, a circuit carrier, a first LED chip, a second LED chip, a first electrode, and a second electrode. The base and the encapsulation cooperatively define a sealed space. The circuit board, along with the first and the second LED chips carried thereon, are received in the sealed space. The first and the second LED chips are electrically connected to the circuit board. The first LED chip is electrically connected with the second LED chip in anti-parallel. The first and the second electrodes are electrically connected to the circuit board so as to supply power to the first and the second LED chips. A LED assembly and a LED string, both employing the aforementioned LED lamp therein, also are provided.

### BACKGROUND

1. Technical Field

The present invention generally relates to the field of semiconductor light emitting devices and, particularly, to light emitting diode lamps, light emitting diode assemblies, and light emitting diode strings.

2. Description of Related Art

In recent years, light emitting diodes (LEDs) have been widely used in consumer and commercial applications, due to their low cost, long life, durability, and low power consumption. Referring to FIG. 4, a typical light emitting diode (LED) assembly 300 is shown. The LED assembly 300 includes a LED lamp 320 and a holder 360. The LED lamp 320 includes a LED chip 326, a first electrode 328, and a second electrode 329 with opposite polarity with respect to that of the first electrode 328. The paired first and the second electrodes 328, 329 are electrically connected with the LED chip 326, so as to supply power to the LED chip 326. The holder 360 includes a plastic fixing member 362 and a base member 366. The plastic fixing member 362 includes two through holes (not labeled) defined therein. The paired first and second electrodes 328, 329 are inserted into and extend through the through holes, and exposed terminals thereof are bent back and attached to outside walls of the plastic fixing member 362. The base member 366 includes a cavity 367 defined therein and paired power supplying electrodes 368 arranged on peripheral walls of the cavity 367. The paired power supplying electrodes 368 generally have wires 369 for external connections. The combination of the LED lamp 320 and the plastic fixing member 362 is partly received in the cavity 367, and the paired first and second electrodes 328, 329, respectively, are attached to and electrically connected with a corresponding one of the paired power supplying electrodes 368. However, in assembly of the LED assembly 300, the operator needs to distinguish from the first electrode 329 and the second electrode 329, due to the difference in the polarities of the first and second electrodes 328, 329, which makes the assembling process time-consuming.

In another aspect, referring to FIG. 5, a circuit connection diagram of a LED string 400, incorporating a number of the above-described LED assemblies 300, is shown. The LED string 400 includes a half-wave rectifier diode D1, a current-limiting resistor R, and a number of LED assemblies 300 connected in series. The half-wave rectifier diode D1 and the current-limiting resistor R both are connected in series with the number of LED assemblies 300. The LED string 400 is powered via an external alternating current (AC) source 500. An AC voltage/current supplied from the AC source 500 will be transformed to a corresponding direct current (DC) voltage/current via the half-wave rectifier diode D1, so as to avoid having the LED assemblies 300 be reverse-biased, and thereby allow the LED assemblies 30 to be lit. However, the LED assemblies 300 only are lit during one of the positive and negative phases of each cycle of the AC voltage/current, which would lower the brightness of the LED string 400 and even cause the occurrence of unwanted blinking.

Therefore, what is needed is a LED lamp, a LED assembly, and a LED string, the latter two both incorporating the LED lamp, which could effectively overcome the above-mentioned disadvantages.

### SUMMARY

A light emitting diode (LED) lamp, in accordance with a present embodiment, is provided. The LED lamp includes a base, an encapsulation, a circuit carrier, a first LED chip, a second LED chip, a first electrode, and a second electrode. The base and the encapsulation cooperatively define a sealed space. The circuit board and the first and the second LED chips are received in the sealed space. The first and the second LED chips are electrically connected to the circuit board and carried thereby. The first LED chip is electrically connected with the second LED chip in anti-parallel. The first and the second electrodes are electrically linked to the circuit board, so as to supply power to the first and the second LED chips.

A LED assembly, in accordance with another present embodiment, is provided. The LED assembly includes a LED lamp, as described above, and a holder. The holder includes a main body and a pair of power supplying electrodes, the first and the second electrodes of the LED lamp respectively being mated and electrically connected with a corresponding one of the power supplying electrodes.

A LED string, in accordance with yet another present embodiment, is provided. The LED string includes a current-limiting resistor and a number of LED assemblies, as described above, connected with each other in series. One terminal of the current-limiting resistor is connected to the LED assemblies, so that the current-limiting resistor and the LED assemblies are electrically connected with each other, in series. Another terminal of the current-limiting resistor is configured (i.e., structured and arranged) for directly connecting to an external alternating current (AC) source.

Compared with the prior art, due to the first and the second LED chips being connected with each other in an anti-parallel manner, a polarity difference between the paired first and second electrodes is eliminated, thus facilitating the assembly of the LED assembly. Furthermore, the LED assembly always can be lit when an AC voltage/current is applied thereto via the AC source, regardless of the positive or the negative phases of the AC voltage/current. Therefore, the brightness would be greatly increased, and the unwanted blinking can be effectively suppressed.

Other advantages and novel features will become more apparent from the following detailed description of embodiments when taken in conjunction with the accompanying drawings.

### BRIEF DESCRIPTION OF THE DRAWINGS

Many aspects of the present LED lamp, LED assembly, and LED string can be better understood with reference to the following drawings. The components in the drawings are not necessarily drawn to scale, the emphasis instead being placed upon clearly illustrating the principles of the present LED lamp, LED assembly, and LED string. Moreover, in the drawings, like reference numerals designate corresponding parts throughout the several views.

FIG. 1 is a schematic, sectional view of a LED assembly, in accordance with a present embodiment, showing a LED lamp.

FIG. 2 is a schematic circuit connection diagram of the LED lamp of FIG. 1.

FIG. 3 is a schematic circuit connection diagram of a LED string, in accordance with another present embodiment.

FIG. 4 is a schematic, sectional view of a LED assembly, in accordance with the related art.

FIG. 5 is a schematic, sectional view of a LED string, in accordance with the related art.

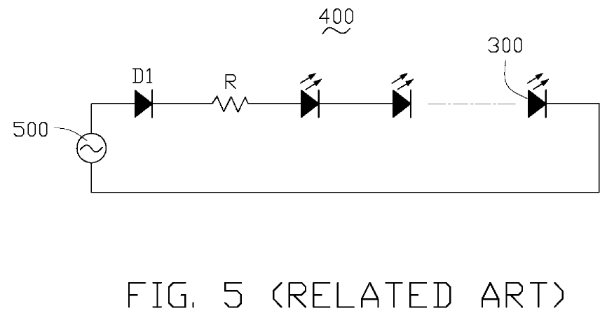

The exemplifications set out herein illustrate various preferred embodiments, in various forms, and such exemplifications are not to be construed as limiting the scope of the present LED lamp, LED assembly and LED string in any manner.

### DETAILED DESCRIPTION

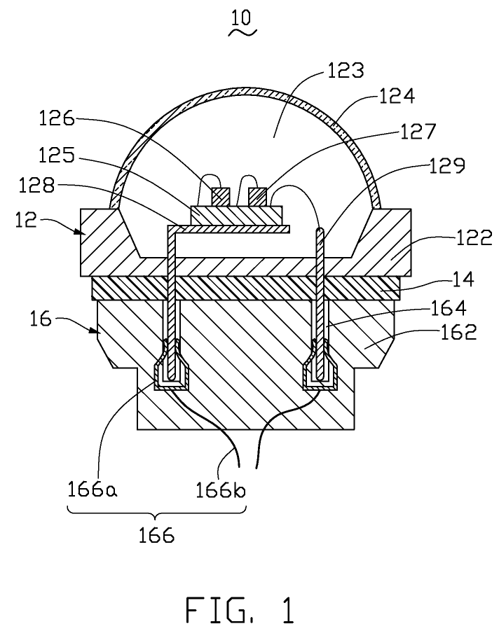

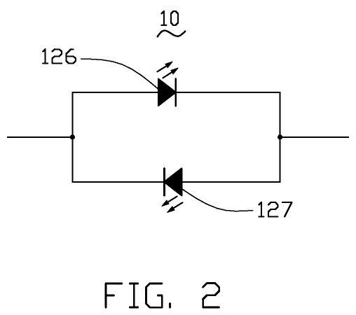

Referring to FIGS. 1 and 2, a light emitting diode (LED) assembly 10, in accordance with a present embodiment, is provided. The LED assembly 10 includes a LED lamp 12 and a holder 16.

The LED lamp 12 includes a base 122, an encapsulation 124, a circuit carrier 125, a first LED chip 126, a second LED chip 127, and paired first and second electrodes 128, 129.

The base 122 and the encapsulation 124 cooperatively define a sealed space 123. In other words, the base 122 and the encapsulation 124 generally cooperatively constitute a light-transmissive chamber. The encapsulation 124 suitably is made from a transparent or translucent material, for example, an epoxy resin. The circuit carrier 125 and the first and second LED chips 126, 127 are received in the sealed space and thus are protected from contamination. The circuit carrier 125 is equipped with electrical connections formed thereon and, rather suitably, is a glass fiber board, a flexible printed circuit board, or a ceramic board. The first and the second LED chips 126, 127 are mounted on and electrically connected to the circuit carrier 125. Thus, the first and the second LED chips 126, 127 could be excited to emit light. As shown in FIG. 2, the first LED chip 126 and the second LED chip 127 are electrically with each other in anti-parallel, i.e., a positive electrode of the first LED chip 126 is connected with a negative electrode of the second LED chip 127, and a negative electrode of the first LED chip 126 is connected with a positive electrode of the second LED chip 127.

The first and the second electrodes 128, 129 penetrate through the base 122 and are electrically connected to the circuit carrier 125, so as to supply power to the first and the second LED chips 126, 127. In fact, the first electrode 128, in the illustrated embodiment, is basically an L-shaped electrode, with a portion thereof extending essentially parallel to the base 122. That portion of the first electrode 128 carries the circuit carrier 125, permitting the circuit carrier 125 to be suspended above the base 122. By being suspended above the base 122 via the circuit carrier 125, the first and the second LED chips 126, 127 can more effectively transmit light through the encapsulation 124. Generally, the first and the second electrodes 128, 129 cooperatively constitute a lead frame of the LED lamp 12. The first and the second electrodes 128, 129 usefully can be made from highly conductive materials, such as copper (Cu), iron (Fe), aluminum (Al), and/or a metal alloy. Due to the first and the second LED chips 126, 127 being connected with each other in an anti-parallel manner, there is no polarity difference between the paired first and second electrodes 128, 129.

The holder 16 includes a main body 162, receiving cavities 164, and paired power supplying electrodes 166.

The receiving cavities 164 are defined in the main body 162 and corresponded to the paired first and second electrodes 128, 129 of the LED lamp 12. In the illustrated embodiment, a pair of receiving cavities 164 is provided. The receiving cavities 164 are configured (i.e., structured and arranged) for receiving the paired first and second electrodes 128, 129 of the LED lamp 12 therein.

The paired power supplying electrodes 166 each include a clip 166a and a wire 166b, connected with the clip 166a. The paired power supplying electrodes 166 are usefully connected with an external circuit (not shown) via the wires 166b thereof, so as to supply power to the LED lamp 12. The clips 166a each can generate a spring force applied to corresponding one of the paired first and second electrodes 128, 129 engaged therewith. As illustrated in FIG. 1, the clips 166a are held in the main body 162, and each clip 166a is partially exposed to the receiving cavities 164. Alternatively, the clips 166a also can be fully exposed to and held in the receiving cavities 164.

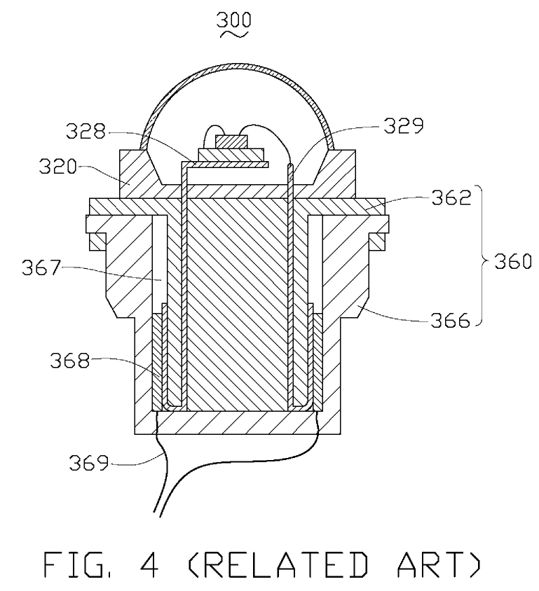

The power supply electrodes 166 of the holder 16 are equipped with the clips 166a, and the first and the second electrodes 128, 129 can be directly engaged with the power supplying electrodes 166 firmly without the need of being bent back. By not having to account for extra length for bending, the length of the paired first and second electrodes 128, 129 could effectively be shortened, thus reducing manufacturing cost. It is indicated that, if the manufacturing cost associated with the extra length for bending in the related art is omitted to be taken in consideration by the manufacturer, the holder 360 illustrated in FIG. 4 also can be employed as the holder 16 of the present LED assembly 10.

Usefully, the LED assembly 10 further includes a waterproof sheet 14 interposed between and in contact with the base 122 of the LED lamp 12 and the holder 16. The paired first and second electrodes 128, 129 (i.e., the lead frame) penetrate through the waterproof sheet 14 and extend into the receiving cavities (i.e., are inserted thereinto). The use of the waterproof sheet 14 would effectively prevent the entry of vapor into the receiving cavities 164 and thus, potentially, damaging the LED assembly 10.

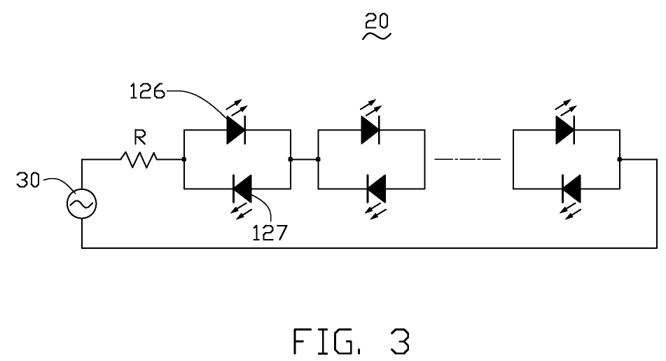

Referring to FIG. 3, a LED string 20, in accordance with another present embodiment, is provided. The LED string 20 includes a current-limiting resistor R and a number of LED assemblies 10, as described above. The LED assemblies 20 are electrically connected with one another, in series. The current-limiting resistor R is electrically connected, in series, with the number of the LED assemblies 20. In particular, one terminal of the current-limiting resistor R is connected to one of the LED assemblies 20, and another terminal is generally connected to an external AC source 30. As above described, each of the LED assemblies 20 includes a first LED chip and a second LED chip electrically connected with each other in anti-parallel.

In operation, an AC voltage/current via an AC source 30 is supplied to the LED string 20. During the positive phase of each cycle of the AC voltage/current, one of the first and the second LED chips 126, 127 of each of the LED assemblies 10 is forward-biased, another one thereof is reverse-biased, and, as a result, the LED assembly 10, as a whole, is lit. Meanwhile, during the negative phase of each cycle of the AC voltage/current, one of the first and the second LED chips 126, 127 of each of the LED assemblies 10 is still forward-biased, another one thereof is reverse-biased, and thus the LED assembly 10, as a whole, is still lit. That is to say, regardless of the positive or the negative phases of the AC voltage/current applied to the LED string 20, the LED assemblies 20 of the LED string always could be lit, based on the present configuration. Accordingly, the whole brightness of the LED string 20 is greatly increased, and the occurrence of unwanted blinking, which tends to occur with the related art arrangement, is suppressed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A light emitting diode lamp, comprising:
a base;
an encapsulation, the encapsulation and the base cooperatively defining a sealed space;
a circuit carrier received in the sealed space;
a first light emitting diode chip and a second light emitting diode chip both received in the sealed space, the first and the second light emitting diode chips both being electrically connected to circuit carrier, the first light emitting diode chip being electrically connected with the second light emitting diode chip in anti-parallel; and a first electrode and a second electrode electrically connected with the circuit carrier so as to supply power to the first and the second light emitting diode chips.

2. The light emitting diode lamp of claim 1, wherein the circuit carrier is selected from the group consisting of a glass fiber board, a flexible printed circuit board, and a ceramic board.

3. The light emitting diode lamp of claim 1, wherein the encapsulation is transparent or translucent.

4. The light emitting diode lamp of claim 1, wherein the first and the second electrodes cooperatively constitute a lead frame of the light emitting diode lamp.

5. A light emitting diode assembly, comprising:
a light emitting diode lamp, the light emitting diode lamp comprising:
a base and an encapsulation cooperatively defining a light-transmissive chamber;
a circuit carrier received in the light-transmissive chamber;
a first light emitting diode chip and a second light emitting diode chip both received in the light-transmissive chamber, the first and the second light emitting diode chips both being electrically connected to circuit carrier, the first light emitting diode chip being electrically connected with the second light emitting diode chip in anti-parallel; and
a first electrode and a second electrode electrically connected with the circuit carrier so as to supply power to the first and the second light emitting diode chips; and a holder comprising a main body and a pair of power supply electrodes, the first and the second electrodes of the light emitting diode lamp respectively being mated and electrically connected with a corresponding one of the power supply electrodes.

6. The light emitting diode assembly of claim 5, wherein the holder further comprises a pair of receiving cavities defined in the main body thereof, the power supply electrodes each includes a clip and a wire connected thereto, the clip of each of the power supply electrodes is at least partially exposed to a corresponding one of the receiving cavities, and the first and the second electrodes are mated and electrically connected with the power supply electrodes, via the clips.

7. The light emitting diode assembly of claim 5, further comprising a waterproof sheet interposed between the base of the light emitting diode lamp and the holder, the first and the second electrodes of the light emitting diode lamp penetrating through the waterproof sheet and extending into the receiving cavities.

8. A light emitting diode string, comprising:
a plurality of light emitting diode assemblies electrically connected with one another in anti-parallel, each of the light emitting diode assemblies comprising:
a light emitting diode lamp, comprising:
a light-transmissive chamber;
a circuit carrier received in the light-transmissive chamber;
a pair of light emitting diode chips received in the light-transmissive chamber and electrically connected to circuit carrier, the light emitting diode chips are electrically connected with each other in anti-parallel; and
a lead frame electrically connected with the circuit carrier so as to supply power to the light emitting diode chips; and
a holder comprising a main body and a pair of power supply electrodes, the lead frame of the light emitting diode lamp being engaged and electrically connected with, respectively, the power supply electrodes; and
a current-limiting resistor having a plurality of terminals associated therewith, one terminal of the current-limiting resistor being electrically connected with one of the power supply electrodes of the holder of one of the light emitting diode assemblies so that the current-limiting resistor and the light emitting diode assemblies are electrically connected with each other, in series, and another terminal being configured for connected to an alternating current source.

9. The light emitting diode string of claim 8, wherein the holder of each of the light emitting diode assemblies further comprises a pair of receiving cavities in the main body thereof, the power supply electrodes each includes a clip and a wire connected thereto, the clip of each of the power supply electrodes is at least partially exposed to a corresponding one of the receiving cavities, the first and the second electrodes are engaged and electrically connected with the power supply electrodes via the clips, and the light emitting diode assemblies are connected in series with each other, via the respective wires of the power supply electrodes.

10. The light emitting string of claim 8, wherein each of the light emitting diode assemblies further comprises a waterproof sheet interposed between the base of the light emitting diode lamp and the holder, the lead frame of the light emitting diode lamp penetrating through the waterproof sheet and extending into the receiving cavities.
